(19) United States
(12) Patent Application Publication
(10) Pub. No.: US 2008/0263914 A1
(43) Pub. Date: Oct. 30, 2008

(54) TILE INSERT

(76) Inventor: Naomi ROSENBACH, Far Rockaway, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/741,853

(22) Filed: Apr. 30, 2007

(51) Int. Cl. G09F 19/00; E04C 1/42

(52) U.S. Cl. 40/1; 52/747.11; 52/315

(57) ABSTRACT

A system for enclosing different ornamental material into an acrylic or ether transparent case for mounting into a cut tile is provided. In particular, ornamental materials, such as beads, crystals, gem stones, pearls, metals, etc. are arranged into some type of pattern or design in order to define a 3-dimensional ornamental element. The ornamental element is then encased within the transparent case. The purpose of the case is to protect the ornamental element encases therein from environmental conditions. The ornamental element is fully visible from within the transparent case. In use, the transparent case housing the ornamental element is directly mounted into a cut tile already fixed on a wall surface. The transparent case is preferably installed so that its top surface is flush with the surface of the tile, facilitating tile cleaning. The tile insert may be used along the wall or ceiling of a room.

This invention relates to a decorative tile, and more particularly, to an insert that is mounted or otherwise received in the tile and which contains some type of ornamental element.

### BACKGROUND OF THE INVENTION

Tiles have been in existence for centuries. Most flies are made of a ceramic or stone base and are opaque. Some tiles are decorated on their front face with 2-dimensional designs. These tiles are often glazed on the front surface to provide for a durable, easy to clean hygienic surface.

Some tiles have a 3-dimensional relief design cut into their front face. However, even if the design is glazed, it is still very difficult to clean a 3-dimensional design as compared to a smooth surface. Thus, if ease of cleaning is important, a tile with a 3-dimensional design on the front face is to be avoided.

Given these limitations, it has been difficult to provide tiles with a visible 3-dimensional ornamental appearance. It has not been possible to use delicate materials, such as jewelry, beads, dried flowers, fabric, sand, or seashells, in order to create an ornamental appearance on the face of a tile. These materials, delicate in nature, would be destroyed as a consequence of everyday use as part of a wall or bathroom tile.

Accordingly, it would be desirable to provide a tile with a visible 3-dimensional ornamental design element made from delicate decorative materials while still maintaining a smooth easy-to-clean tile front face.

### SUMMARY OF THE INVENTION

Generally speaking, in accordance with the invention, a system for enclosing different ornamental materials into an acrylic or other transparent case for later placement or mounting within a standard tile is described. In particular, ornamental materials, such as beads, crystals, gem stones, pearls and other jewelry, as well as metals, dried flowers, dried leaves, bamboo, fabric, sand, sea shells etc., are arranged into some type of pattern or design in order to define a 3-dimensional ornamental element. The ornamental element is then encased within the transparent case. The purpose of the case is to protect the ornamental element encased therein from moisture and heat. The transparent case also enables the ornamental materials to be used and visible; before the invention, such delicate materials could not be used to decorate tile.

In use, the transparent case housing the ornamental element is directly mounted into a tile by cutting into the tile and then mounting the case into at least a portion of the cut-out area following tile installation on a wall or other surface. Preferably, the transparent case should be installed so that the top surface is flush with the surface of the tile, thereby facilitating tile cleaning.

Accordingly, the invention is directed to a decorative file that includes a cutout made to receive a transparent material so that an ornamental element retained therein is visible.

The invention is further directed to a decorative tile in which the top surface thereof is substantially flush with the top surface of a tile insert when received in a cutout of the tile.

The invention also is directed to a tile insert comprising a case made from a material selected from the group including acrylic, glass and plastic.

Moreover, the invention is directed to a tile insert which contains a jewelry element comprising a plurality of jewelry components selected from the group including beads, crystals, gem stones, pearls and metal elements.

These features of the invention, as set forth above, will in part be obvious and will in part be apparent from the following description. Moreover, the scope of the invention will be indicated in the claims found at the end hereof.

### BRIEF DESCRIPTION OF THE DRAWINGS

For a fuller understanding of the invention, reference is made to the following description, taken in connection with the accompanying drawings, in which:

FIG. 1 is an exploded perspective view of the inventive tile insert;

FIG. 2 is a perspective view of the inventive tile insert being mounted in a cutout of a tile element;

FIG. 3 is a cross-sectional view taken along line 3-3 of FIG. 2;

FIG. 4 is an exploded perspective view of an alternative form of the inventive tile insert;

FIG. 5 is a perspective view of the inventive tile insert being mounted into an opening defined by a plurality of tile element cutouts; and

FIG. 6 is an exploded perspective view of a second alternative form of the inventive tile insert.

### DETAILED DESCRIPTION OF A PREFERRED EMBODIMENT

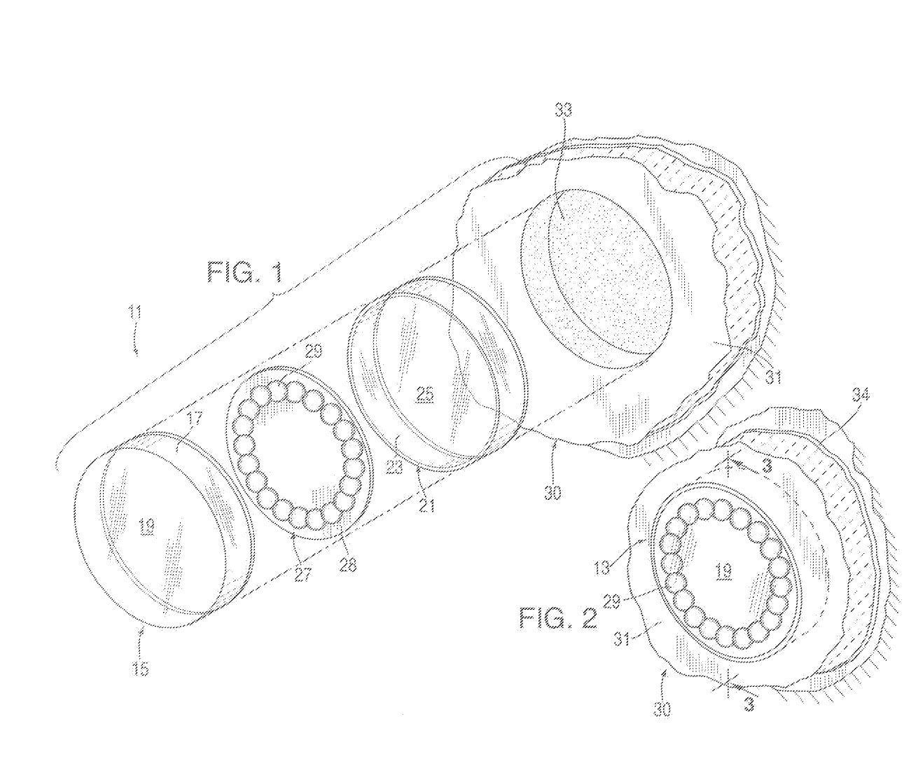

Referring to FIG. 1, a tile insert for containing a decorative element and made in accordance with the invention is generally indicated at 11. Insert 11 includes a transparent case 13 (see FIG. 2) defined by a cover 15 and a base 21. Cover 15 includes a top portion 19 and a depending annular side wall 17, while base 21 includes a bottom portion 25 and a depend big annular side wall 23. Top portion 19 of cover 15 must have at least a portion thereof that is transparent. Bottom portion 25 of base 21 may also be transparent, but it can also be opaque, depending in large part on whether a backing is used for mounting the decorative element in the tile insert as described later below.

Each of covers 15 and base 21 are, for purposes of ease of manufacture, most preferably integrally formed from a transparent or translucent durable material, such as acrylic, glass and plastic. The preferred acrylic is methacrylic and preferred plastics include polystyrene, poly-propylene and poly-carbonate.

Bach of cover 15 and base 21 has a hard scratch-resistant surface, preferably achieved by a tempering process. Tempering is a secondary process used in the production of materials such as glass or plastic, whereby the application of heating and cooling enables the structure to harden beyond its usual characteristics. In addition to being scratch resistant, tempering also provides additional breakage resistance from dropping or due to compression/crushing.

In accordance with the invention, the use of an acrylic material for cover 15 as well as base 21 is preferred, since it is most suitable for a tempering process. Moreover, an acrylic material has a lower cost than other materials without appreciable reduction in performance characteristics. Acrylic is also long lasting and can be molded to any desired shape.

Production of each of cover 15 and base 21 is preferably achieved by injection molding. In injection molding, a polymer resin is pre-dried, then heated, and thereafter injected into the mold of the desired shape. With respect to case 13, both cover 15 and base 21 are formed by injection molding using molds having corresponding circular configurations. However, case 13 may have any desired shape so long as it is mountable in a tile, as described below. Further, case 13 should have a height or thickness of equal to or less than ⅜ of an inch, the standard thickness of a conventional wall tile.

Before closing together cover 15 and base 21, an ornamental element 27, preferably of a 3-dimensional configuration, is disposed along the inside surface of the bottom 25 of base 21. Ornamental element 27 may be made of any combination of materials and any shape or design that is otherwise aesthetically pleasing. In the embodiment shown in FIGS. 1-3, ornamental element 27 includes a plurality of beads 29 formed into a ring-like configuration. In general ornamental element 27 may preferably be made of one or more combinations of jewelry elements, including beads, crystals, gem stones, pearls and metal elements. In addition, ornamental element 27 may also be made of fabric components, ether alone or in combination with jewelry components, in order to create an aesthetically pleasing ornamental presentation.

Further, ornamental element 27 may include other decorative items such as bamboo, plant elements such as dried flowers and dried leaves, sand and seashells, or any other component(s) that can be used to create an attractive, visually appealing ornamental design.

In order to mount ornamental element 27 along the inside surface of base bottom 25, ornamental element 27 may be directly adhered by glue or other adhesive (see FIGS. 4 and 5). As a result, and so the wall on which the tile with the received insert is installed, is not visible, bottom portion 25 of base 21 should be made of an opaque material. Alternatively, bottom portion 25 of base 21 can be made of a colored glass or acrylic for providing an enhanced decorative effect.

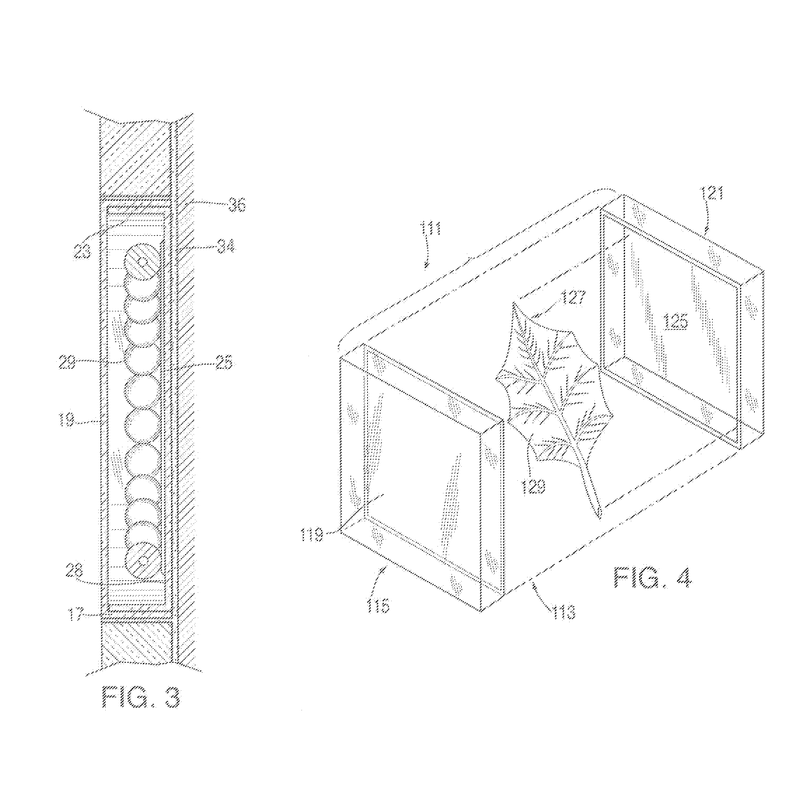

In a preferred form, ornamental element 27 is supported along a frame or backing 28 (see FIGS. 1 and 3), which is, in turn, affixed to bottom 25 of base 21. Backing 28 may be made of metal, paper, cardboard, and any other material that is suitable for supporting ornamental element 27, and is also decorative in presentation. Significantly, backing 28 should preferably be sized so as to cover or overlie the entire inside surface of bottom portion 25 of base 21 so that the wall on which the tile with the received insert is installed is not visible when viewing decorative element 29 in case 13.

Importantly, and however mounted, decorative element 27 must be fixed in position (fixed directly to bottom 25 of base 21, or instead to backing 28) so it does not shift around.

Once ornamental element 27 is fixed in position within case 13, cover 15 and base 21 are sealed together in an airtight fashion (to prevent moisture from entering), as best shown in FIGS. 2 and 3, in order to form tile insert 11. Sealing may be achieved by a force fit arrangement or by adhering side wall 17 of cover 15 to side wall 23 of base 21. To facilitate closing of cover 15 over base 21, cover 15 will have a width dimension that is slightly larger than that of base 21, thereby enabling cover 15 to fit tightly over base 21. To further facilitate the closing of cover 15 over base 21 in order to form case 13, glue or another adhesive may be used (possibly cured by using a U-V light source). Case 13 now provides a protective housing for ornamental element 27 when tile insert 11 is mounted in a tile cutout, as described below.

Continuing now with FIGS. 2-3, a tile element 30 is shown having an outside surface 31 and a cutout 33 formed therethrough. Cutout 33 is made in a size and shape that is the same as the size and shape of insert 11 so that insert 11 may be snugly fit within cutout 33 after mounting the element 30 to a wall 36 or some other surface. It is noted that cutout 33 can be made at any location along tile element 30; cutout 33 does not need to be centered although that may be preferred from a design standpoint. Further, surface 31 of tile element 30 is contiguous with and otherwise flush to the outside surface of top 19 of cover 16 so that there is a smooth transition between the surfaces of tile element 30 and insert 11 when the latter is received within cutout 33. This arrangement facilitates repeated cleaning of the tile and provides a polished and professional looking appearance after installation. Alternatively, top 19 of insert cover 15 can extend beyond surface 31 of tile element 30 for providing a different decorative effect.

In accordance with the invention, after forming cutout 33 in tile element 30, tile element 30 is adhered to wall 36 or other supporting surface by means of an adhesive 34. Then, insert 11 (with ornament element 27 mounted therein) is mounted within cutout 33 and fixed to wall 36 also by means of adhesive 34. A novel and decorative tile (see FIGS. 2 and 3) is thereby created.

In FIG. 4, there is shown an alternative embodiment of a tile insert in accordance with the invention and generally indicated at 111. Tile insert 111 is defined by a transparent cover 115 having a top 119, an opaque base 121 and an ornamental element 127 defined by a leaf 129. Ornamental element 127 is adhered directly to bottom 125 of base 121. Cover 115 and base 121 are rectangular in configuration and together define a case 113 in which ornamental element 127 is fixedly mounted.

As shown in FIG. 5, tile insert 121 is adhesively mounted between a series of tiles 30 installed along a wall 136 or other supporting surface by means of adhesive 134. In particular, each of tiles 30 is formed with a cutout; the cutouts abut one another when flies 130 are installed along wall 136 in order to define a rectangular or square void within the series of tiles 130. This void defined by the abutting tiles 130 is sized for accommodating tile insert 121 therewith. As before, tiles 130 have outside surfaces 131 that are flush with the surface of top 119 of insert cover 115.

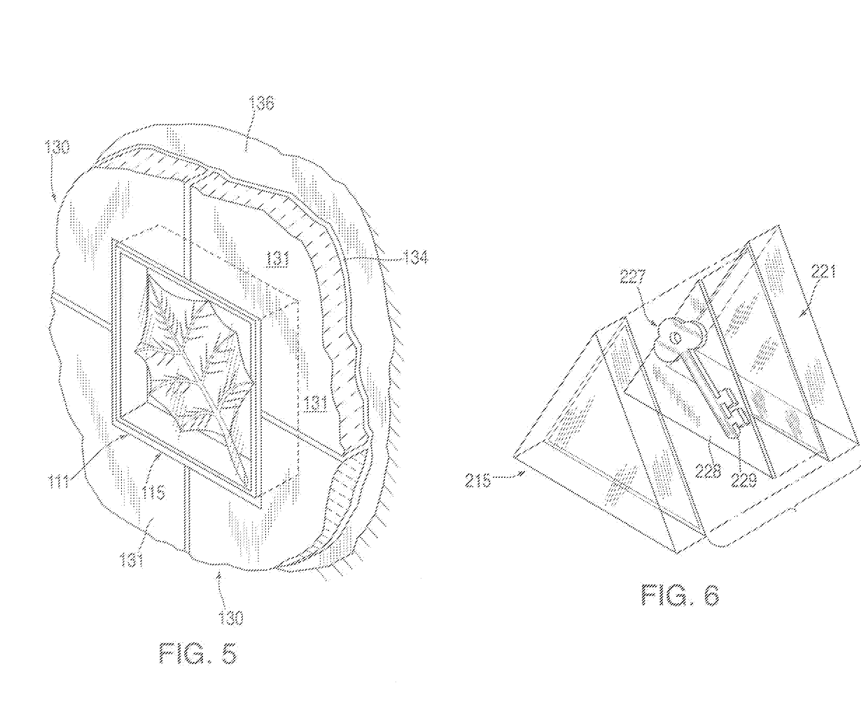

In the embodiment shown in FIG. 6, a tile insert generally indicated at 211 includes a transparent cover 215 and a transparent base 221 with a bottom 225, as well as an ornamental element 227 defined by a key 229 and fixedly mounted along a metal frame 228. Frame 228 is preferably glued to bottom 225 of base 221 in order to fix element 227 in position within tile insert 211. Both cover 215 and base 221 are triangular in configuration and together define a case 213 within which ornamental element 227 is mounted.

Significantly, and for whatever shape case that is used, the case must be tightly closed or sealed with the enclosed ornamental element such that moisture and heat is prevented from getting inside the case. This enables one to use any type of delicate jewelry or other materials in forming the ornamental element without incurring the risk of damage during tile installation and/or prolonged wear of the insert.

The scope of the invention will now be indicated in the following claims.

1. A decorative tile assembly comprising a tile element formed with a cutout and a tile insert with at least a part thereof fixedly received within said cutout, said tile insert comprising a case having a top with at least a portion thereof that is transparent and an ornamental element fixedly mounted in the case and visible through said transparent top portion.

2. The tile assembly of claim 1, wherein said tile element has a front surface that is substantially flush with said case top when said case is received in at least said portion of said tile cutout.

3. The tile assembly of claim 11 wherein the case includes a cover component formed with said top, and a base component formed with a bottom.

4. The tile assembly of claim 3, wherein said cover component and said base component are closed together in order to form said case.

5. The tile assembly of claim 4, wherein saw cover component includes a side wall, and said base component includes a side wall, said side walls fitting one over the other when said cover component and said ease component are closed together.

6. The tile assembly of claim 3, wherein said cover and base components of said case are each integrally formed of a transparent material.

7. The tile assembly of claim 6, wherein said components of said case are made from a material selected from the group consisting of acrylic, glass and plastic.

8. The tile assembly of claim 1, wherein said ornamental element comprise a plurality of arranged jewelry components.

9. The tile assembly of claim 8, wherein said jewelry components are selected from the group consisting of crystals, beads, gem stones, pearls and metal elements.

10. The tile assembly of claim 1, wherein said ornamental element is selected from the group consisting of jewelry elements, fabric elements and plant elements.

11. The tile assembly of claim 1, wherein the case component has a scratch resistant surface.

12. The tile assembly of claim 13, wherein said scratch resistance surface is achieved by a tempering process.

13. The tile assembly of claim 3, wherein said cover and base components are made by injection molding.

14. The tile assembly of claim 3, wherein said ornamental element is fixed to a frame that is attached to said bottom of said base component.

15. The tile assembly of claim 14, wherein said frame is made from a material selected from the group consisting of metal and paper.

16. The tile assembly of claim 14, wherein said frame completely overlies said bottom of said base component.

17. A method for decorating a tile comprising the stops of:
removing a part of said tile in order to produce a tile cut-out;
placing an ornamental element inside an enclosed case having a top with a transparent portion such that said ornamental element is visible in the case through said top transparent portion; and
mounting at least a part of sale case in said tile cut-out with said case top facing outwardly.

18. The method of claim 17, wherein said tile has a facing surface and wherein said amounting step includes fitting said at least a part of said case in said tile such that the top of the case is flush with respect to said facing surface of said tile.

19. The method of claim 17, wherein said case includes a cover containing said top and a base containing sale bottom, and wherein said ornamental element is planed in said case prior to closing said cover and base together.

20. The method of claim 17, further including the step of installing said tile along a surface after said removing step one prior to said reconfirm step.

21. An insert for a tile, the insert comprising a case having a top with at least a portion thereof being transparent and an ornamental element mounted in the case and visible through said transparent portion.
